(19) United States
(12) Patent Application Publication
(10) Pub. No.: US 2011/0267661 A1
(43) Pub. Date: Nov. 3, 2011

(54) BOOK SCANNING DEVICE

(75) Inventors: Jonathan Hayes, Boston, MA (US); Paul Williamson, Providence, RI (US); Brian Shim, Providence, RI (US)

(73) Assignee: ION Audio, LLC, Cumberland, RI (US)

(21) Appl. No.: 13/099,931

(22) Filed: May 3, 2011

Related U.S. Application Data
(63) Continuation-in-part of application No. 29/389,021, filed on Apr. 6, 2011.
Application No. 29/389,021 is a continuation-in-part of application No. 29/389,022, filed on Apr. 6, 2011.
Application No. 29/389,022 is a continuation-in-part of application No. 29/389,025, filed on Apr. 6, 2011.
(60) Provisional application No. 61/330,613, filed on May 3, 2010.

(51) Int. Cl. H04N 1/04

(52) U.S. Cl. 358/474

(57) ABSTRACT

An apparatus for scanning pages of bound materials is disclosed. The apparatus includes a base with a platform configured to support bound materials laid open. A depressor with a complimentary surface is provided to depress pages of the bound material flat against the platform of the base. The depressor has a transparent portion allowing the pages of the bound material to be viewed therethrough. The depressor is removable from the base. A camera assembly is connected to and supported over the depressor. At least one camera attached to the camera assembly and aimed towards the transparent portion of the depressor. The camera is configured to capture a digital image of at least one page of the bound material through the transparent portion of the depressor when the depressor is placed over a bound material that is laid open in the platform of the base.

### CROSS-REFERENCE TO RELATED APPLICATIONS

The present patent document claims priority to earlier filed U.S. Provisional Patent Application Ser. No. 61/330,613, filed on May 3, 2010, the entire contents of which are incorporated herein by reference. The present patent document is also a continuation in part of earlier filed U.S. Design patent application Ser. Nos. 29/389,021, 29/389,022, and 29/389,025, all filed on Apr. 6, 2011, the entire contents of which are incorporated herein by reference.

### BACKGROUND

1. Technical Field

The present patent document relates generally to digital scanning devices and more specifically to a scanning device optimized for scanning the pages of books, magazines and other bound papers.

2. Background of the Related Art

Scanning pages into a digital format for use on a computer is known in the art. However, the prior art devices have various disadvantageous when used to scan bound materials, such as books and periodicals.

Flatbed Scanners are cheap and ubiquitous, but are not ideal for scanning multiple pages of a book. Flatbed scanners are slow, and require the user to open a hinged lid, place the book down face down on a flat scanning surface, close the lid, wait for the scan, open the lid, turn the page, and repeat the process. Some flatbed scanners do not have a large enough scanning surface to scan two pages at once either, which increases the time spent scanning. Even when sufficiently large for a 2-page spread, significant downward pressure is needed to flatten the inseam of the binding to minimize distortion within the inside margin. In short, flatbed scanners are awkward to use when scanning bound materials.

Overhead scanners are relatively inexpensive but do a poor job at scanning books due to the distortion of the pages. Without something pressing down on the pages to make them flat, scan quality can be poor.

Professional grade book scanners do exist, but are too expensive for the ordinary consumer. In the professional book scanner, the glass page-flattening panels move up and down on a railing to allow the user to turn the page in-between scans. In addition, the base runs side-to-side on tracks in order to adjust the centerline of the book to the cameras. Professional book scanners require a lot of expensive moving parts, rails, and wheels, and are often fitted with more expensive cameras too.

Accordingly, there is a perceived need in the art for a book scanning device that is inexpensive, yet provides the ability to efficiently and easily scan bound materials.

### SUMMARY

The present invention solves the problems of the prior art by providing a book scanning device that can inexpensively and easily scan a bound book, magazine, manuscript, and the like without removing the pages from the book (i.e., no damage to the book or binding).

One objective of the book scanning device is including the capacity to produce a high quality scan, yet at a low cost. Another objective is to provide a book scanning device that is relatively compact so the consumer will not have to devote a lot of space for the device. Another objective is the provision for a book scanning device that permits rapid scanning of books so the consumer will not have to spend a lot of time operating the device.

### BRIEF DESCRIPTION OF THE DRAWINGS

These and other features, aspects, and advantages of the book scanning device will become better understood with reference to the following description, appended claims, and accompanying drawings where:

FIG. 1 is a perspective view of an embodiment of a book scanning device with a book, shown in broken lines, being placed within the device;

FIG. 2 is a perspective view of an embodiment of a book scanning device a book in position and device ready for scanning;

FIG. 3 is a perspective view of an embodiment of a book scanning device with the left camera activated;

FIG. 4 is a perspective view of an embodiment of a book scanning device with the right camera activated;

FIG. 5 is a perspective view of an embodiment of a book scanning device with the user opening the device and turning the page in the book to scan the next pages;

FIG. 6 is a perspective view of an alternative embodiment of a book scanning device;

FIG. 7 is a left side elevation view of an alternative embodiment of a book scanning device, it being understood the right side is the mirror-image thereof;

FIG. 8 a front elevation view of an alternative embodiment of a book scanning device, it being understood the rear elevation view is a mirror-image thereof;

FIG. 9 is a partial exploded view of the alternative embodiment of the book scanning device showing the camera assembly and page compressor portion separated from the cradle portion with a book, depicted in broken lines, resting in the cradle portion;

FIG. 10 is a perspective view of a cradle portion of an alternative embodiment of a book scanning device showing the cradle erected for; and

FIG. 11 is a perspective view of the cradle portion of an alternative embodiment of a book scanning device showing the cradle folded for storage.

### DESCRIPTION OF THE PREFERRED EMBODIMENTS

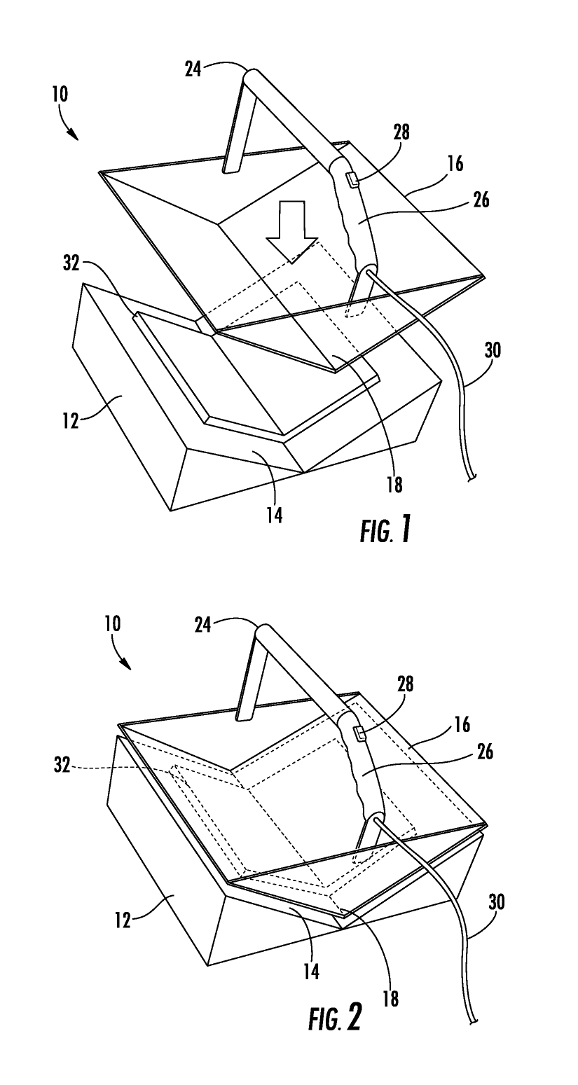

Referring now the FIGS. 1-5, an embodiment of the book scanning device is generally shown at 10. The term “book” as used within this patent document refers to any bound material having a number of pages, such as, but not limited to, magazines, periodicals, bound sheet music, spiral bound books, perfect bound books, soft cover books, hard cover books and the like. The book scanning device 10 includes a base 12 with a V-shaped scanning platform (or cradle) 14 with a depressor 16 having a complimentary V-shaped surface 18 that fits into the V-shaped platform 14. Although the platform 14 and depressor 16 are preferably V-shaped, other complimentary shapes could be used.

The depressor 16 is transparent or clear to permit one or more cameras 20, 22, described further below, to see through the depressor 16 to the scanning platform 14 on the base 12. A handle 24 is centered over the depressor 16. Within the handle 16 is a camera and lights. A single camera may be provided with left and right lenses that are selectively activated, or a left camera 20 and a right camera 22 are provided (as shown). The left camera (or left lens) 20 is focused at a left portion of the V-shaped scanning platform 14 of the base 12. The right camera (or right lens) 22 is focused at a right portion of the V-shaped scanning platform 14 of the base 12.

The handle 24 further includes a grip 26 with a shutter button 28. Pressing the button 28 activates the cameras 20 and lights 21, which scans the scanning platform 14 as described further below. By integrating the camera and lighting elements into a handle 24 that is attached to the V-shaped depressor 16, the book scanning device 10 ensures that the scans are centered on each page regardless of whether the beginning or the end of the book 32 is being scanned.

Extending from the handle 24 is a power cord 30. Optionally, the depressor may be battery powered.

Images captured by the camera(s) 20, 22 may be stored in an optional memory card inserted into a memory card slot, a non-removable memory, transmitted directly to a computer via a serial connection, such as a universal serial bus cable, or transmitted wirelessly through a computer compatible transmitter, such as a Bluetooth or 802.11 compliant transmitters.

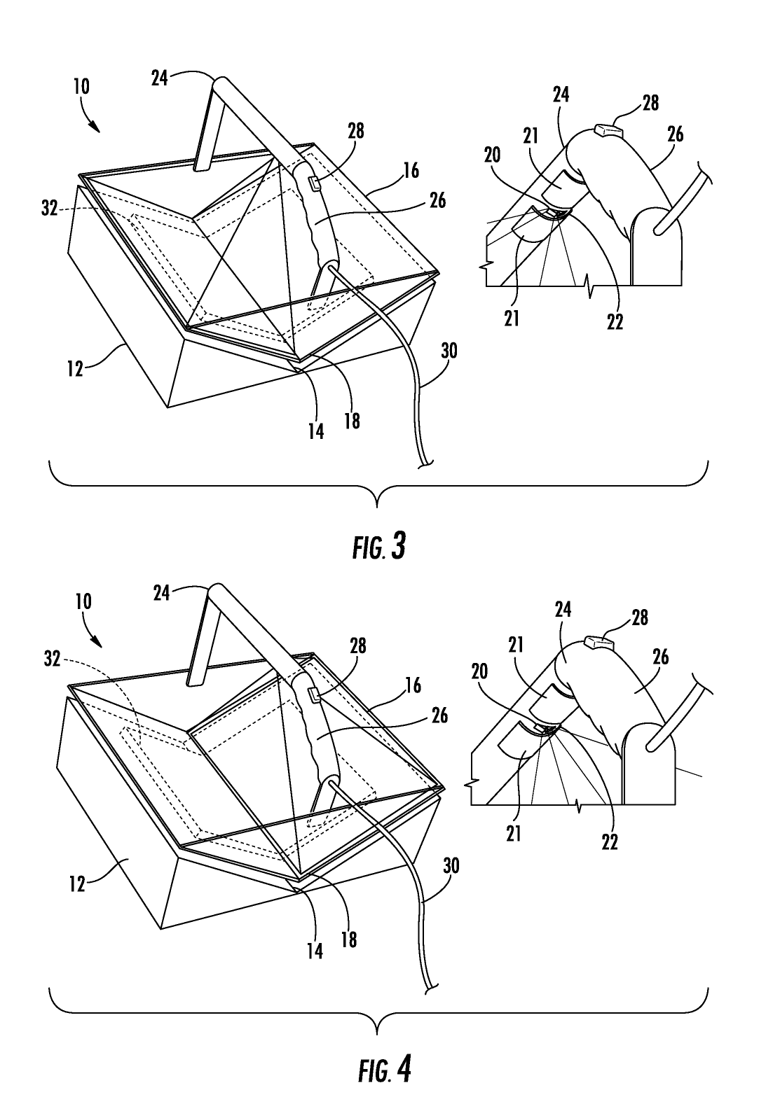

As shown in FIGS. 1 and 2, a book, periodical or other bound material 32 is placed in the platform 14 open to the pages that are desired to be scanned. The user then presses the shutter button 28 to activate the cameras 20, 22 and capture digital images of the pages.

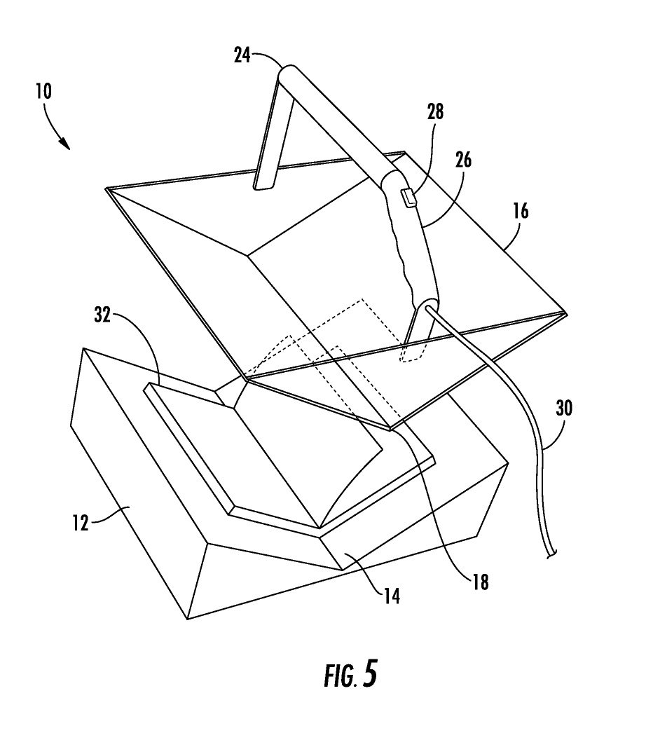

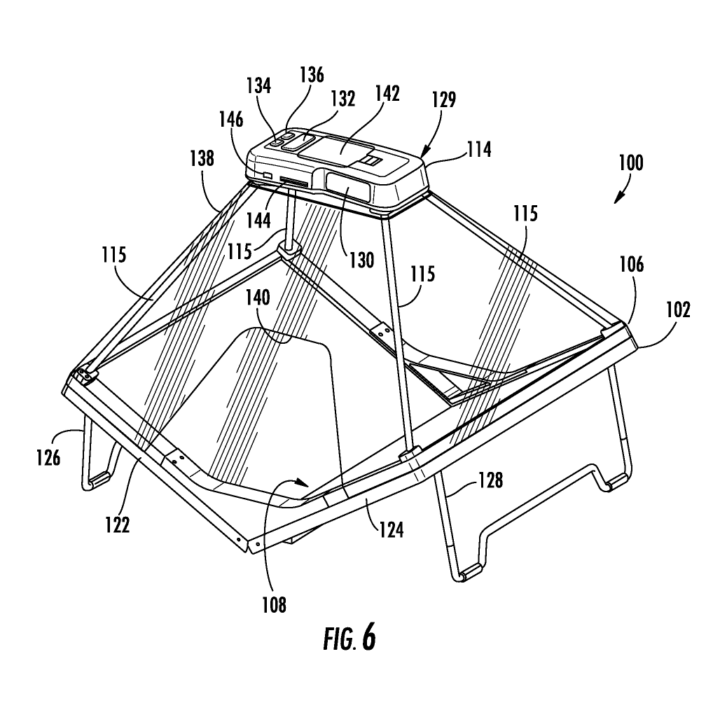

Referring to FIG. 3 now, the left camera (or lens) 20 is selected for scanning. The left page of the material to be scanned is captured by the camera (or lens) 20. The sequence then repeats for the right camera (or lens) 22 as shown in FIG. 4. Specifically, the right page of the material to be scanned is captured by the camera (or lens) 22. Optionally, the cameras (or lenses) 20, 22 may simultaneously capture images of both the left and right pages at once. The digital images may be stored as separate files containing an image for each page separately, or as a single file containing an image of both pages.

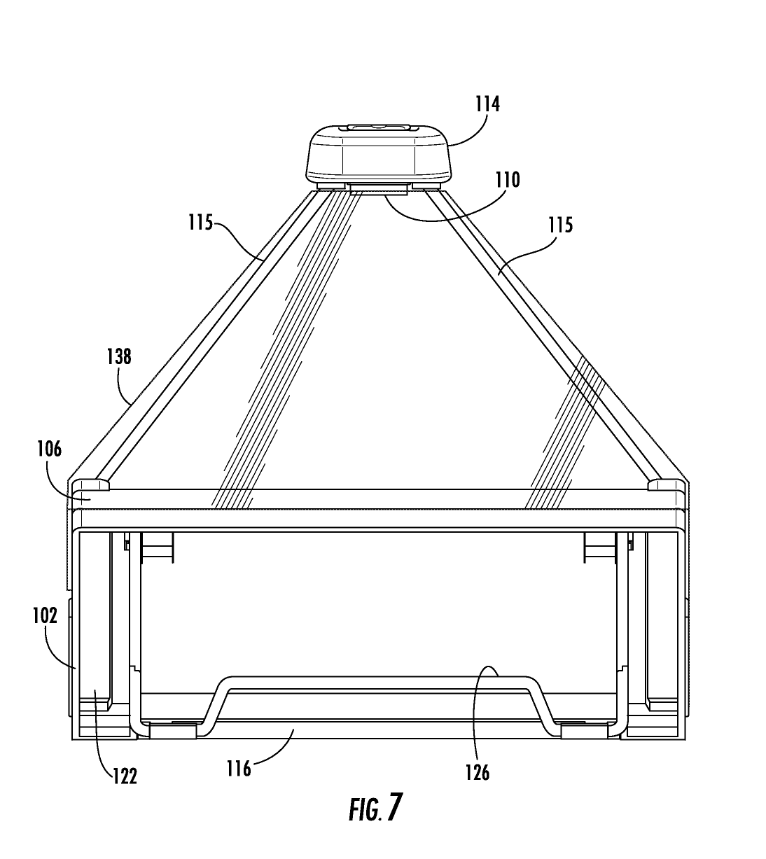

Referring to FIG. 5, the user then lifts the depressor 16 and turns the page of the book or periodical 32 and replaces the depressor 16 to continue the scanning operation. The user repeats the sequence of events depicted in FIGS. 1-5 until all desired pages have been scanned.

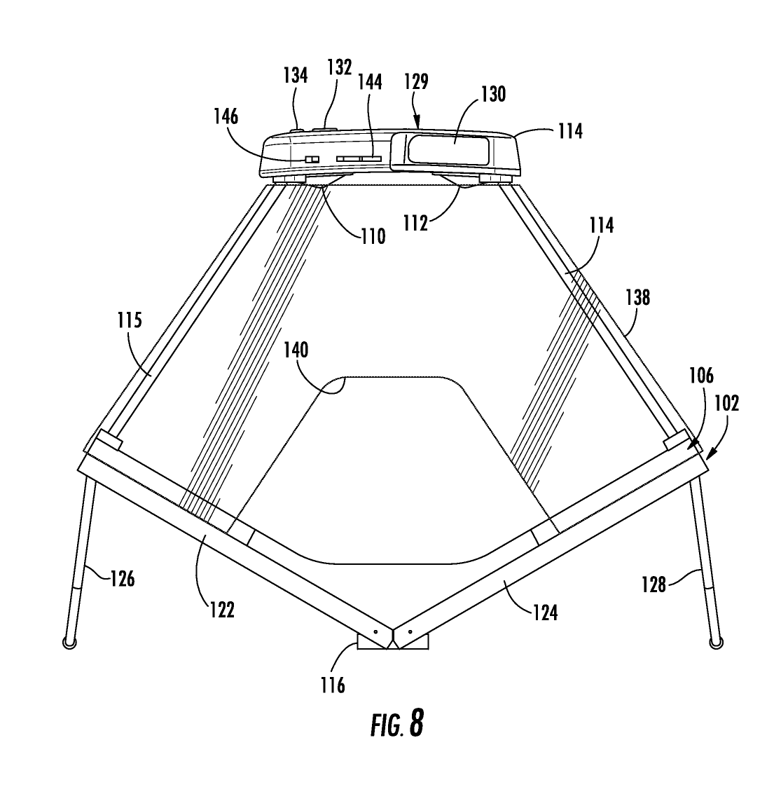

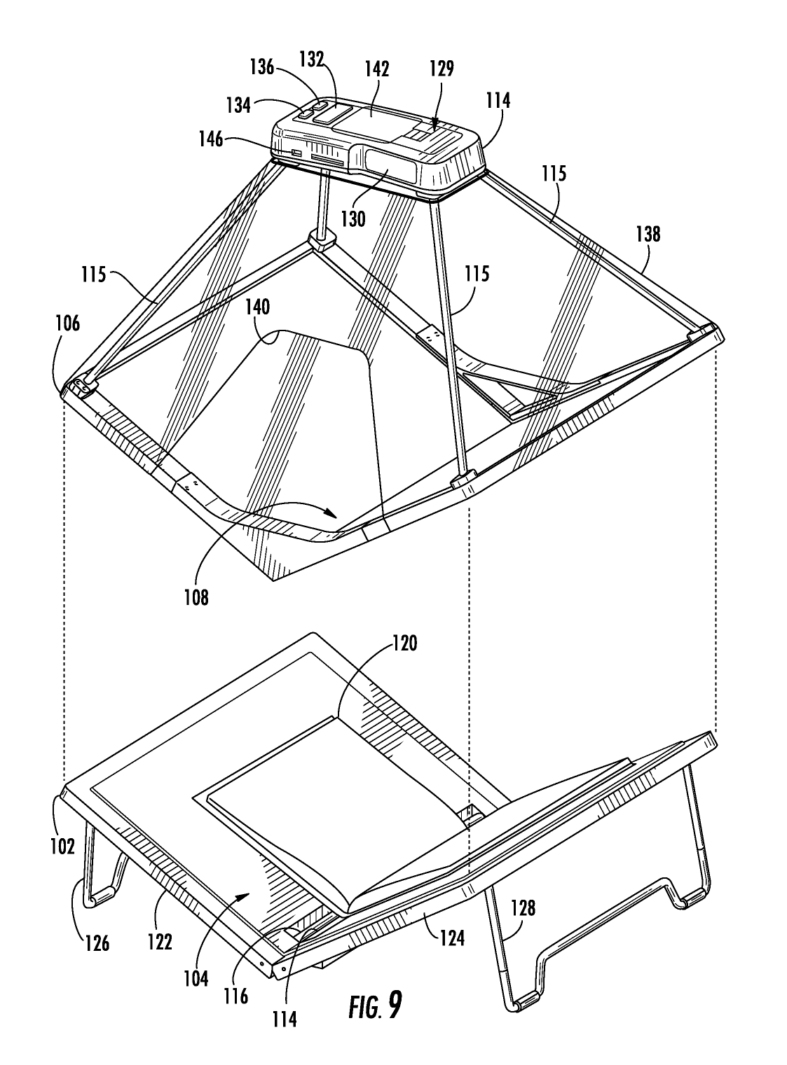

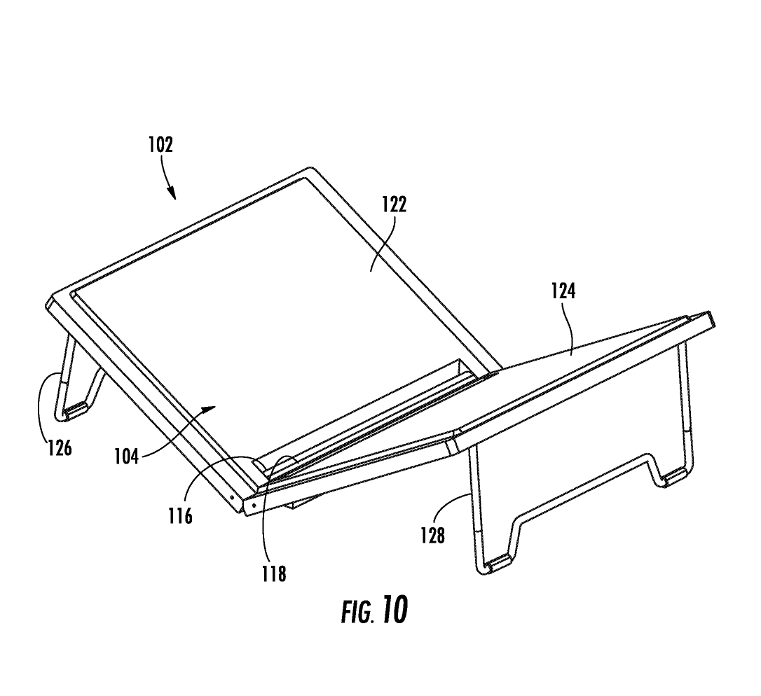

Referring now to FIGS. 6-11, an alternative embodiment of the book scanning device is shown generally at 100. The book scanning device 100 includes a base 102 with a V-shaped scanning platform (or cradle) 104 with a depressor 106 having a complimentary V-shaped surface 108 that fits into the V-shaped platform 104. Although the platform 104 and depressor 106 are preferably V-shaped, other complimentary shapes could be used.

The depressor 106 includes a transparent or clear portion to permit one or more cameras 110, 112, described further below, to see through the depressor 106 to the scanning platform 104 on the base 102. A camera assembly 114 is centered over the depressor 106 via four struts 115. Each strut 115 is connected to a corner of the camera assembly 114 and a corner of the depressor 106. Within the camera assembly 114 is a camera and lights. A single camera may be provided with left and right lenses that are selectively activated, or a left camera 110 and a right camera 112 are provided (as shown). The left camera (or left lens) 110 is focused at a left portion of the V-shaped scanning platform 104 of the base 102. The right camera (or right lens) 112 is focused at a right portion of the V-shaped scanning platform 104 of the base 102.

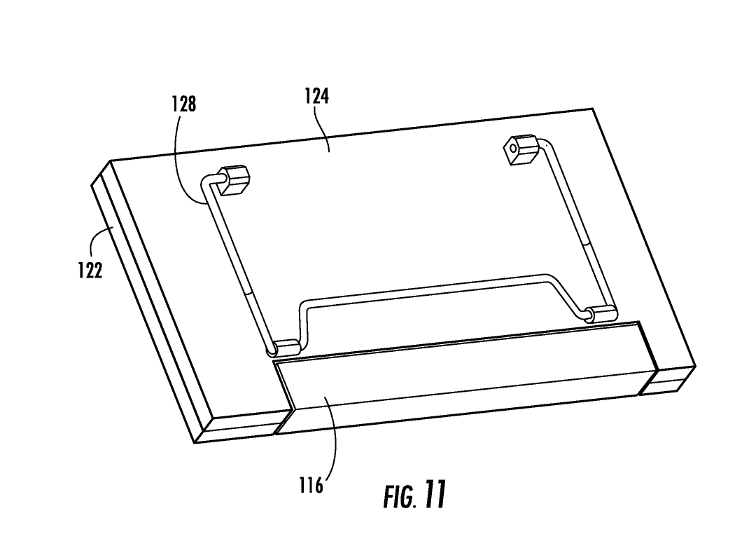

The base 102, best seen in FIGS. 10 and 11, includes a center support 116 with a central groove 118 configured to support the spine of a bound material 120. A left platform portion 122 is hinged to a left side of the center support 116. A right platform portion 124 is hinged to a right side of the center support 116. Together, the right platform portion 124, left platform portion 122 and center support 116 forms the scanning platform 104. A left support leg 126 is hinged to a bottom surface of the left platform portion 122. A right support leg 128 is hinged to a bottom surface of the right platform portion 124. The left support leg 126 and right support leg 128 fold against the left platform portion 122 and right platform portion 124, respectively, and the left platform portion 122 and right platform portion 124 pivot about the center support 116 and fold together to close the base 102 like a book itself, as shown in FIG. 11.

The camera assembly 114 further includes a handle 129 with one or more grips 130 to permit the user to easily move or place the camera assembly 114 and depressor 106 off of or onto the base 102. The handle 129 is formed by narrowing a portion of the camera assembly 114 to permit a user to comfortable grip the camera assembly 114. The camera assembly 114 further includes a scan button 132. Pressing the scan button 132 activates the cameras 110, 112 and lights, which scans the scanning platform 104 as described further below. By integrating the cameras 110,112 and lighting elements into the camera assembly 114 that is attached to the V-shaped depressor 106, the book scanning device 100 ensures that the scans are centered on each page regardless of whether the beginning or the end of the bound material 120 is being scanned.

The scan button 132 is preferably includes two portions that are pressable. That is, the scan button includes a left portion and right portion that may be individually pressed to perform the scanning operation in the proper sequence depending upon the orientation of the book scanning device 100 to the user. The reason is due to the fact that the handle 129 of the camera assembly 114 may be held by the user's right hand or left hand, depending upon their preference. When the user switches hands, the depressor and camera assembly may be rotated 180 degrees so that the buttons align up with the user's index finger. Because the orientation has now been switched, though, the scan order (or capture sequence of the cameras 110, 112) needs to also change or the result will be that the scan operates on the right page first, then the left, putting the pages out of sequence. One portion of the scan button 132 captures the left camera 110 first and then the right camera 112 second. The other portion of the scan button 132 captures the right camera 112 first and then the left camera 110 second. When the user is holding the handle 129, the user's index finger naturally rests on the correct portion of the scan button 132.

Further included is a USB button 134, which toggles the book scanning device 100 from scan mode to function as a USB mass-storage class device when connected to a personal computer. That is, when the USB button 134 is pressed the book scanning device 100 functions as a mass-storage device, which enables the transfer of digital images from the book scanning device 100 to the personal computer.

A power button 136 is provided to activate and deactivate the camera assembly 114 as needed.

A light diffusing tent 138 is suspended around the four struts, between the camera assembly and depressor 106. The light diffusing tent minimizes light reflections off of the transparent portions of the depressor. An opening 140 into the light diffusing tent is provided so the user may easily place and remove bound materials 120 into or out of the scanning platform 104.

The camera assembly 114 may be battery powered by putting batteries in the battery compartment 142. Optionally, the camera assembly may be powered via power-over-USB, when the USB button 134 is in scan mode.

To perform a scan, a book, periodical or other bound material 120 is placed in the platform 104 open to the pages that are desired to be scanned. The user then presses the scan button 132 to activate the cameras 110, 112 and capture digital images of the pages.

The left camera 110 is selected for scanning. The left page of the material to be scanned is captured by the camera 110. The sequence then repeats for the right camera 112. Specifically, the right page of the material to be scanned is captured by the camera 112. Optionally, the cameras 110, 112 may simultaneously capture images of both the left and right pages at once. The digital images may be stored as separate files containing an image for each page separately, or as a single file containing an image of both pages.

The user then lifts the depressor 106 and turns the page of the book or periodical 120 and replaces the depressor 106 to continue the scanning operation. The user repeats the sequence of events until all desired pages have been scanned.

Images captured by the camera(s) may be in an optional memory card may be inserted into a memory card slot 144, a non-removable memory, transmitted directly to a computer via a serial connection, such as a universal serial bus cable, or transmitted wirelessly through a computer compatible transmitter, such as a Bluetooth or 802.11 compliant transmitters. A universal serial bus port 146 is provided to connect the camera assembly to a personal computer.

Therefore, it can be seen that the book scanning device embodying features of the present invention provides a unique solution to the problem of how to inexpensively and easily scan a bound book, magazine, manuscript, and the like into electronic form without removing the pages from the book (i.e., no damage to the book or binding). By physically attaching the camera and lighting elements to the clear depressor, instead of to a book ‘holder’, the device of the present invention ensures that the camera elements are always centered on each page. As can be appreciated, the book scanning device of the present invention provides an inexpensive, and simple method of centering the camera elements on the page, which surpasses the prior art techniques that require expensive rails to guide the lenses to the desired position.

It would be appreciated by those skilled in the art that various changes and modifications can be made to the illustrated embodiments without departing from the spirit of the present invention. All such modifications and changes are intended to be within the scope of the present invention.

What is claimed is:

1. An apparatus for scanning pages of bound materials, comprising:
a base with a platform configured to support a bound material laid open;
a depressor with a complimentary surface to the platform of the base configured and arranged to depress pages of the bound material flat against the platform of the base, said depressor having a transparent portion allowing the pages of the bound material to be viewed therethrough, said depressor removable from the base and not attached thereto;
a camera assembly connected to and supported over the depressor; and
at least one camera attached to the camera assembly and aimed towards the transparent portion of the depressor, said camera configured and arranged to capture a digital image of at least one page of the bound material through the transparent portion of the depressor when the depressor is placed over a bound material that is laid open in the platform of the base.

2. The apparatus of claim 1, wherein the at least one camera comprises a first camera aimed towards a left portion of the platform and a right camera aimed towards a right portion of the platform.

3. The apparatus of claim 1, further comprising at least one light configured and arranged to shine down towards the transparent portion of the depressor and onto the pages of the bound material supported by the platform of the base.

4. The apparatus of claim 1, wherein the camera assembly further comprises a memory card slot configured and arranged to receive a removable memory card therein.

5. The apparatus of claim 1, further comprising a computer interface port configured and arranged to transmit a digital image captured by said at least one camera to a personal computer.

6. The apparatus of claim 1, further comprising a wireless adapter configured and arranged to transmit a digital image captured by said at least one camera to a personal computer.

7. The apparatus of claim 1, wherein said camera assembly comprises a handle with a grip.

8. The apparatus of claim 1, further comprising a tent made of a light diffusing material suspended around said camera assembly and said depressor.

9. The apparatus of claim 1, wherein said base further comprises:
a center support having a central groove configured to support the spine of a bound material;
a left platform portion hinged to a left side of the center support;
a right platform portion hinged to a right side of the center support;
a left support leg hinged to a bottom surface of the left platform portion; and
a right support leg hinged to a bottom surface of the right platform portion;
wherein the left support leg and right support leg may fold against the left platform portion and right platform portion, respectively, and the left platform portion and right platform portion may pivot about the center support and fold together.

10. The apparatus of claim 1, further comprising four struts connecting the camera assembly to the depressor and supporting the camera assembly over the depressor.

11. The apparatus of claim 1, wherein said platform has a v-shaped depression and said depressor has a v-shaped complimentary surface.

12. The apparatus of claim 1, wherein the camera assembly is centered over the depressor.

13. An apparatus for scanning pages of bound materials, comprising:
a base with a platform configured to support a bound material laid open;
a depressor with a complimentary surface to the platform of the base configured and arranged to depress pages of the bound material flat against the platform of the base, said depressor having a transparent portion allowing the pages of the bound material to be viewed therethrough, said depressor removable from the base and not attached thereto;
a camera assembly supported over the depressor via four struts connected to the camera assembly and depressor, respectively;
a first camera aimed towards a left portion of the platform and a right camera aimed towards a right portion of the platform;
a camera attached to the camera assembly and aimed towards the transparent portion of the depressor, said camera configured and arranged to capture a digital image of at least one page of the bound material through the transparent portion of the depressor when the depressor is placed over a bound material that is laid open in the platform of the base.

14. The apparatus of claim 13, further comprising at least one light configured and arranged to shine down towards the transparent portion of the depressor and onto the pages of the bound material supported by the platform of the base.

15. The apparatus of claim 13, wherein the camera assembly further comprises a memory card slot configured and arranged to receive a removable memory card therein.

16. The apparatus of claim 13, further comprising a computer interface port configured and arranged to transmit a digital image captured by said at least one camera to a personal computer.

17. The apparatus of claim 13, further comprising a wireless adapter configured and arranged to transmit a digital image captured by said at least one camera to a personal computer.

18. The apparatus of claim 13, further comprising a tent made of a light diffusing material supported by the four struts, between said camera assembly and said depressor.

19. The apparatus of claim 13, wherein said base further comprises
a center support having a central groove configured to support the spine of a bound material;
a left platform portion hinged to a left side of the center support;
a right platform portion hinged to a right side of the center support;
a left support leg hinged to a bottom surface of the left platform portion; and
a right support leg hinged to a bottom surface of the right platform portion;
wherein the left support leg and right support leg may fold against the left platform portion and right platform portion, respectively, and the left platform portion and right platform portion may pivot about the center support and fold together.

20. The apparatus of claim 13, wherein said platform has a v-shaped depression and said depressor has a v-shaped complimentary surface.

21. The apparatus of claim 13, wherein the camera assembly is centered over the depressor.
